(19) United States
(12) Patent Application Publication
(10) Pub. No.: US 2016/0144321 A1
(43) Pub. Date: May 26, 2016

(54) GRAPHENE FILTERING SHEET AND METHOD OF FABRICATING THE SAME

(71) Applicant: Chung Yuan Christian University, Taoyuan City (TW)

(72) Inventors: Wei-Song HUNG, Taichung City (TW); Wei-Jen LIU, Taoyuan City (TW); Yu-Jing CHIU, Taichung City (TW); Yueh-Ching YANG, Taoyuan City (TW); Chien-Chieh HU, Taoyuan City (TW); Kueir-Rarn LEE, Taoyuan City (TW); Juin-Yih LAI, Taoyuan City (TW)

(21) Appl. No.: 14/931,436

(22) Filed: Nov. 3, 2015

(30) Foreign Application Priority Data
Nov. 20, 2014 (TW) 103140184

(51) Int. Cl. B01D 69/14; B01D 71/08; C02F 1/44; B01D 71/02

(52) U.S. Cl. CPC B01D 69/148; B01D 71/024; B01D 71/08; C02F 1/44; B01D 2325/02

(57) ABSTRACT

A graphene filtering sheet is disclosed. The sheet includes a reduced grapheme oxide (r-GO) dispersed in a polymer with the reduced grapheme oxide (r-GO) having a chemical structure with C/O ratio ranging from 0.1 to 50. The reduced grapheme oxide is obtained via hydrothermal method. The graphene filtering sheet has a capacity of separating alcohol from water with an efficiency approximated to 100%.

### FIELD OF THE INVENTION

The present invention relates to a filtering sheet and its fabricating method thereof, particularly, relates to a graphene filtering sheet and its fabricating method thereof.

### BACKGROUND OF THE INVENTION

Graphene is a material of excellent mechanical strength, thermal conductivity and electrical conductivity. The carrier mobility of graphene can be nearly 200,000 cm²/V·S. Due to its outstanding physical properties, graphene is now applying for many industrial usage such as the production of semiconductor, touch panel and solar power converting devices. Currently, the fabricating method of graphene includes mechanical exfoliation, epitaxial growth, chemical vapor deposition, CVD, and chemical exfoliation . . . etc.

Nowadays there are many ways fabricating monolayer graphene sheets, such as mechanical exfoliation, Epitaxial growth, chemical vapor deposition, and chemical exfoliation. Monolayer graphene sheets can be detached from an already existing graphite crystal by rubbing its surface. This method of obtaining graphene sheets is called “mechanical exfoliation”. But there are disadvantages of the mechanical exfoliation method of graphene sheets fabrication. Such as, picking up graphene sheets of high quality during the mechanical exfoliation selection process troubles a lot and it's hard to control the sizes of gained graphene sheets. By this method, we can't stably produce graphene sheets big enough for industrial use. Graphene sheets can also be grown directly on a substrate surface. It is a method so called “epitaxial growth”. This method uses ruthenium to be a matrix where graphene sheets can be grown on. The method is as followed: Firstly, applying carbon to the ruthenium matrix, made them filtrate into the ruthenium matrix under 2102° F. (1150° C.). And then, cooling down to 1562° F. (850° C.) to make the carbon atoms surfaced the ruthenium matrix and becoming a monolayer graphene sheet. By this process, graphene sheets will layer up original ones, and outer layers can then be separate from the ruthenium matrix easily. The two methods mentioned above can produce graphene sheets of quality higher than the above, but can't be used for fabricating graphene sheets of large pieces. An another method called “chemical vapor deposition” which grows graphene sheets on surface of copper or nickel and transfers the grown graphene sheet to some other matrix needed, can fabricate graphene sheets of large pieces. But the transferring process causes mechanical damage of graphene sheets, lower the yield, and on the other hand brings problems of residual contamination. Moreover, the cost of graphene sheets fabrication by this method is higher.

There's still another method of preparing graphene sheet called “chemical exfoliation” that costs low during production and can make graphene sheet with large pieces. In chemical exfoliation method graphene must be oxidized to be graphene oxide at first, and then be reduced by high-temperature annealing method or strong reductants treatment to recover its electrical conductivity. However, there are also some disadvantages of this method. High-temperature annealing method might over reduce graphene oxide, make it aggregate, and then higher the follow up machining cost. On the other hand, strong reductants such as N₂H₄, sodium borohydride, hexamethylenetetramine . . . etc., which been used in chemical exfoliation process, causes environmental pollution. In addition, the graphene lattice might be damaged during oxidation process in chemical exfoliation method of graphene sheet fabrication, and the reduction rate of graphene oxide can't reach 100%.

Nowadays graphene is utilized in semiconductor and electrical products, seldom been used in filtering membrane for water depuration. The present invention provides a graphene filtering sheet which has a capacity of separating alcohol from water with an efficiency approximated to 100%. The present invention also provides a simple graphene sheet fabricating method that won't cause environmental pollution.

### SUMMARY OF THE INVENTION

An objective of the present invention is to provide a graphene filtering sheet and its fabricating method thereof. Present graphene filtering sheet comprises a reduced graphene oxide, which has a ratio of C/O (carbon/oxygen) content structure of 0.1-50, the reduced graphene oxide was dispersed in a macromolecule to become a macromolecule composite sheet.

In one embedment, the pore sizes of the macromolecule composite sheet ranging from 1 μm-100 μm.

In one embedment, reduced graphene oxide was dispersed in chitosan.

In one embedment, the graphene filtering sheet has a capacity of separating alcohol from water with an efficiency higher than 99%, and the alcohol is selected from the group consisted of methanol, ethanol, propanol and isopropanol.

Present invention also provides a method of for fabricating a graphene filtering sheet, comprises the steps of: adding a graphene oxide in water, to delaminate the graphene oxide to obtain a graphene oxide dispersion solution; performing a hydrothermal reduction process to the graphene oxide dispersion solution at a constant temperature ranging from 30° C.-100° C., and at a constant time period from 10 minutes to 72 hours, to obtain a reduced graphene oxide dispersion solution with a ratio of C/O (carbon/oxygen) content of 0.1-50; and drying the reduced graphene oxide (r-GO) dispersion solution.

The method of graphene filtering sheet production in present invention, wherein the step of drying the reduced graphene oxide (r-GO) dispersion solution is achieved by vacuum filtration.

In one embedment, the delamination of the graphene oxide is achieved by sonication.

In one embedment, the method of graphene filtering sheet production in present invention further comprises a step of adding a macromolecule solution into the reduced graphene oxide (r-GO) dispersion solution.

The graphene filtering sheet produced in present invention has a capacity of separating alcohol from water with an efficiency approximated to 100%, and the method of producing reduced graphene and graphene filtering sheet is simple and do not cause environmental pollution.

### BRIEF DESCRIPTION OF THE DRAWINGS

The present invention will be apparent to those skilled in the art by reading the following description of a preferred embodiment thereof with reference to the drawings, in which:

FIG. 1 is a schematic view of the structure of reduced graphene oxide in first embedment of present invention;

FIG. 2 is a flow chart of second embodiment of present invention of graphene oxide synthesizing method;

FIG. 3 is a flow chart of third embodiment of present invention of fabricating reduced graphene oxide;

FIG. 4A-4F is XPS atom analyzed diagrams of reduce graphene oxide under different reduction times of third embodiment in present invention;

FIG. 5A is a schematic view of fourth embodiment of present invention of graphene filtering sheet structure;

FIG. 5B is a schematic view of fifth embodiment of present invention of graphene filtering sheet structure;

FIG. 5C is photos of surfaces of graphene filtering sheets under different reduction time of hydrothermal reduction;

FIG. 5D is electron microscopy photos of surfaces of graphene filtering sheets under different reduction times of hydrothermal reduction; and

FIG. 6 is a flow chart of forth embodiment of present invention of fabricating graphene filtering sheet.

### DETAILED DESCRIPTION OF THE PREFERRED EMBODIMENT

In the following detailed description of the preferred embodiments, reference is made to the accompanying drawings which form a part hereof, and as shown by way of illustration specific embodiments in which the invention may be practiced. As such, the directional terminology is used for purposes of illustration and is in no way limiting the present invention.

The present invention fabricates reduced-graphene oxide (r-GO) filtering sheet. Utilizing hydrothermal reduction method to reduce graphene oxide (GO) and, by control the hydrothermal reduction level of reduced-graphene oxide (r-GO), manufacturers can obtain reduced-graphene oxide (r-GO) of different C/O (carbon/oxygen)ratio, and further, different hydrophilicity and hydrophobicity, electro conductivity, thermal conductivity, dispersion property, compatibility to macromolecules, and workability. In present invention, graphene oxide (GO) can be obtained by purchasing, or synthesizing. The processes of graphene oxide (GO) synthesizing yields products that chemically oxidized and delaminated from graphite.

In the present invention, the term of “reduced-graphene oxide, r-GO” refers to the graphene with different ratio of CIO content structure. The different ratio of CO/ content structure of graphene was achieved by using a regulating hydrothermal reduction process under constant temperature within a certain period of time.

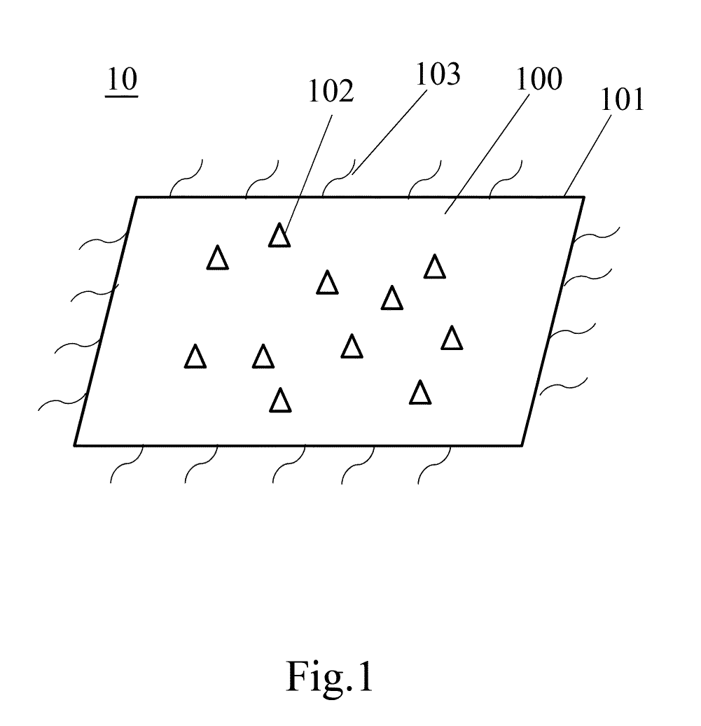

As shown in FIG. 1, the first embedment of the present invention shows the structure of reduced graphene oxide 10. This reduced graphene oxide 10 comprises majorly of polycyclic aromatic hydrocarbons, with sp² hybridization, forms two dimensional hexagonal lattice sheet structure. The sp² hybridized thin pieces has basal plane 100, which contains a plurality of first functional groups 102, and an edge plane 101, which contains a plurality of second functional groups 103. The amounts of functional groups can be adjusted by control the degree of reduction of reduced graphene oxide 10 during hydrothermal reduction method. Higher degree of reduction will cause the reduced graphene oxide 10 with higher ratio of C/O content, and the plurality of first functional groups 102 is getting less on the basal plane 100.

The ratio of C/O content of reduced graphene oxide 10 can be 0.1˜50. The different ratio of C/O content will influence the structural property of reduced graphene oxide 10, and further make the reduced graphene oxide 10 to be a conductor, a semiconductor or an insulator. The reduced graphene oxide 10 will be the insulator when ratio of C/O content between about 1˜3, semiconductor when about 4˜10, and conductor when about 11˜50.

Moreover, the different ratio of C/O content of reduced graphene oxide 10 will also influence its hydrophilicity and hydrophobicity. The functional groups on the structure of reduced graphene oxide make it hydrophilic, and the π-bond aromatic rings of its structure make it hydrophobic conversely. By adjusting the ratio of C/O content of reduced graphene oxide 10 and further verified the hydrophilicity and hydrophobicity of it, can make the reduced graphene oxide 10 suitable for dissolve in different solutions or macromolecules of different hydrophilic and hydrophobic property. Thereby, enhance the ease of industrial processing. The first functional group 102 on basal plane 100 can be epoxy group (—C—O—C—), hydroxyl group (C—OH), or their combination thereof. Otherwise, the functional groups on basal plane 100 can be functional groups without epoxy groups or hydroxyl groups, and the second functional groups 103 on the edge plane 101 can be carboxyl groups (—COOH). The structure of reduced graphene oxide 10 can be monolayer or multi-layer sheets with thickness between 1 nm and 5 μm. The thickness of monolayer reduced graphene oxide is 1 nm, and the distance between layers of the multi-layer is 0.1 nm to 50 nms.

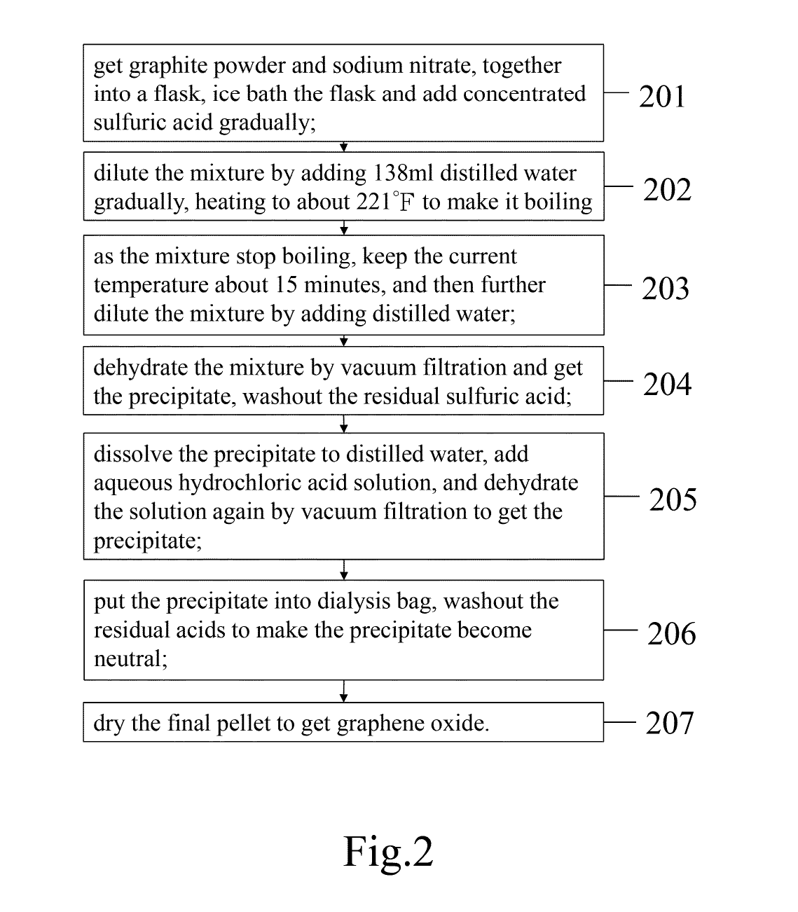

As shown in FIG. 2, the second embedment of the present invention provides a synthesizing method of graphene oxide. The method is as followed: step 201: get graphite powder 3 g and sodium nitrate 1.5 g, together into a flask, ice bath the flask and add 72 ml concentrated sulfuric acid gradually; step 202: dilute the mixture by adding 138 ml distilled water gradually, heating to about 221° F. (105° C.) to make it boiling; step 203: as the mixture stop boiling, keep the current temperature about 15 minutes, and then farther dilute the mixture by adding 420 ml distilled water; step 204: dehydrate the mixture by vacuum filtration and get the precipitate, washout the residual sulfuric acid; step 205: dissolve the precipitate to distilled water, add aqueous hydrochloric acid solution, and dehydrate the solution again by vacuum filtration to get the precipitate; step 206: put the precipitate into dialysis bag, washout the residual acids to make the precipitate become neutral; and step 207: dry the final pellet to get graphene oxide. The obtained graphene oxide in this embedment is graphene oxide of fully oxidized, the ratio of C/O content structure of this graphene oxide is 1-5, in other words, the oxygen content is equal to or more than the carbon content.

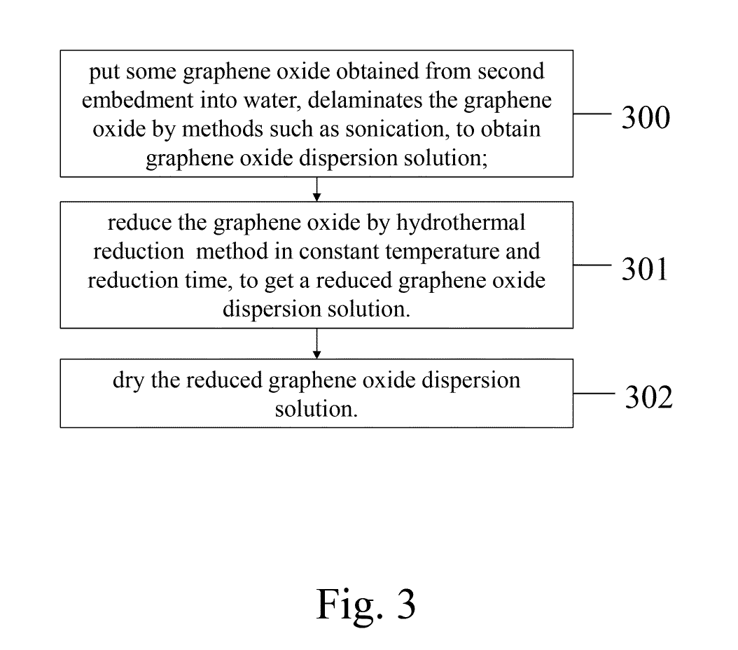

As shown in FIG. 3, the third embedment of the present invention provides a synthesizing method of reduced graphene oxide 10 (r-GO). The method is as followed: step 300: put some graphene oxide obtained from second embedment into water, delaminates the graphene oxide by methods such as sonication, to obtain graphene oxide dispersion solution; step 301: reduce the graphene oxide dispersion solution by hydrothermal reduction method in constant temperature and reduction time, to get a reduced graphene oxide 10 (r-GO) dispersion solution. Different reaction temperature and reduction time causes reduced graphene oxide 10 (r-GO) dispersion solution of different C/O ratio. The reaction temperature can be 80° F.-212° F. (30° C.-100° C.). The preferred reaction condition is 10 minutes to 72 hours under 194° F. (90° C.). To get the best dispersion solution of forming graphene filtering sheet, the reduction time is 12 hours. Step 302: dry the reduced graphene oxide 10 (r-GO) dispersion solution by methods such as vacuum filtration.

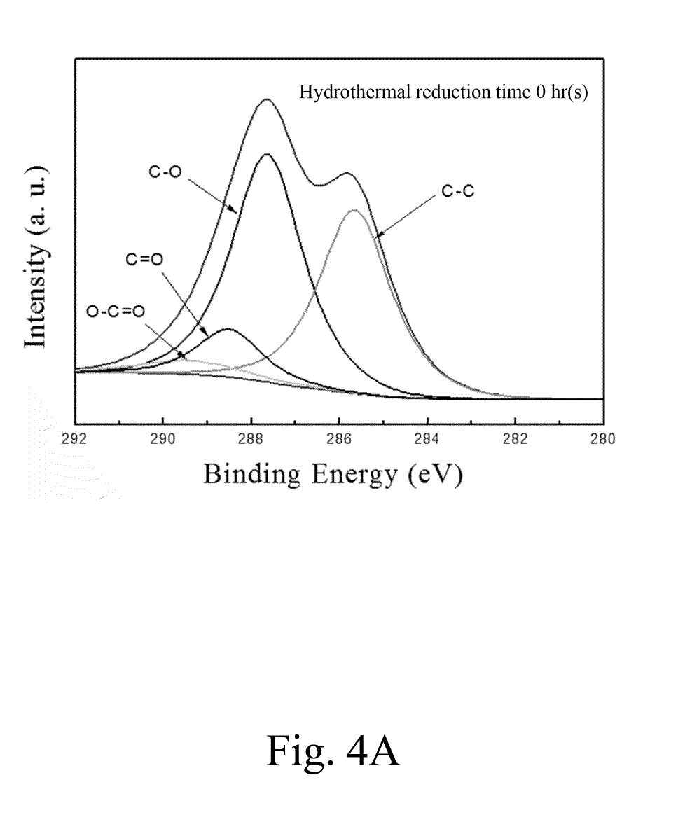

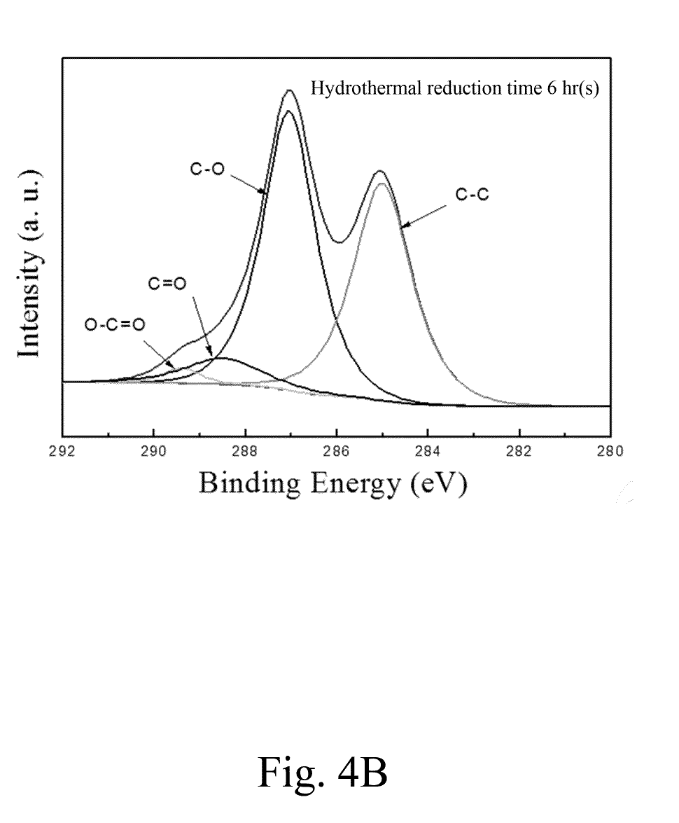

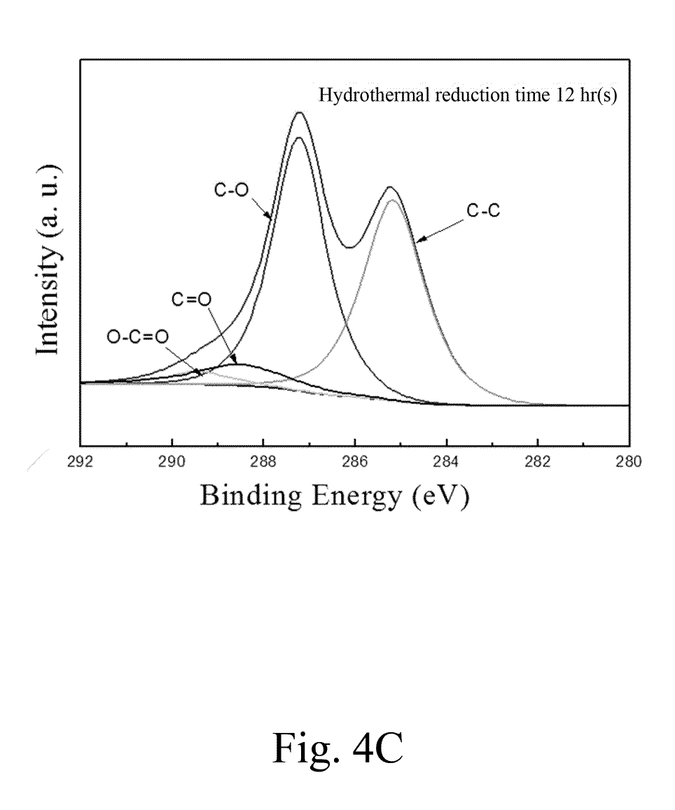

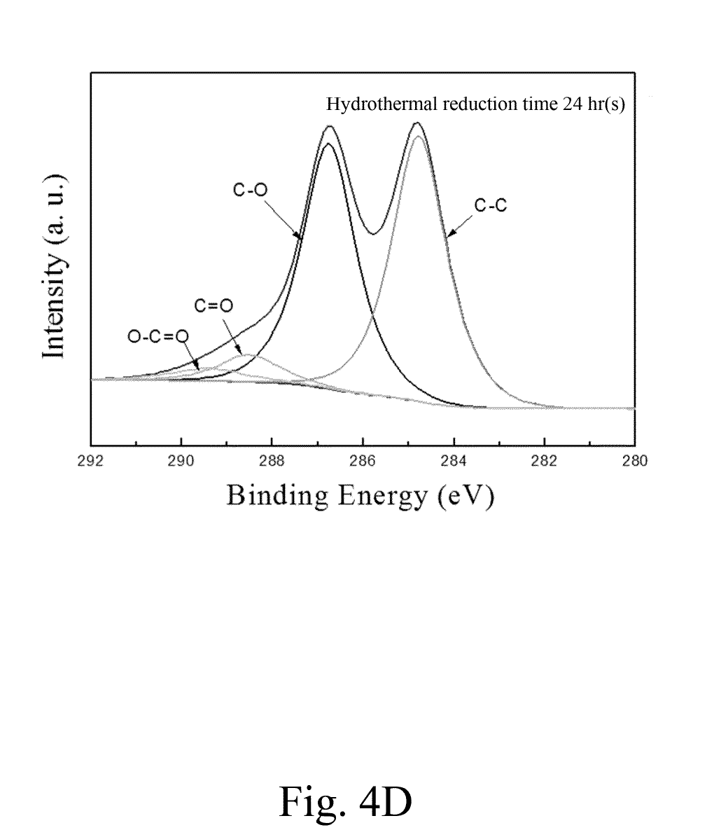

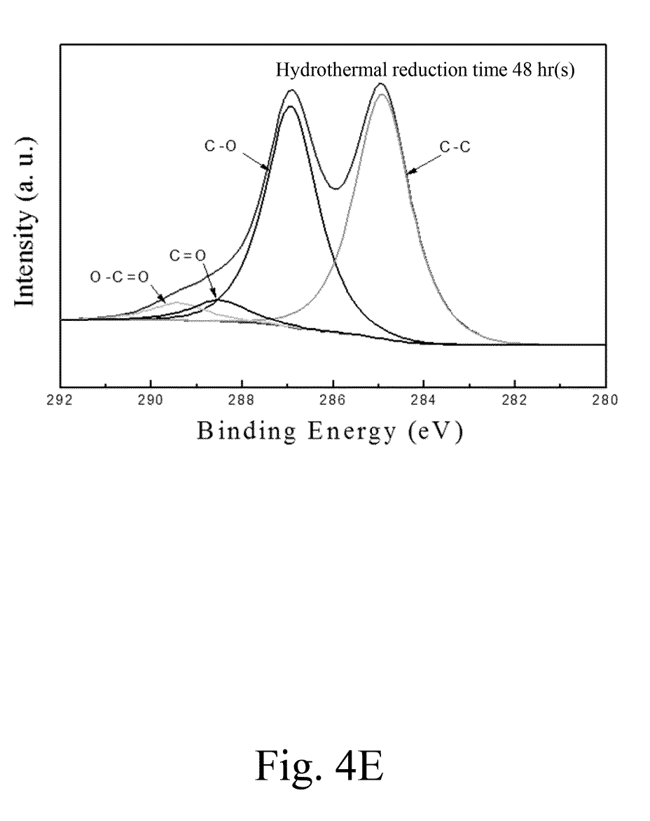

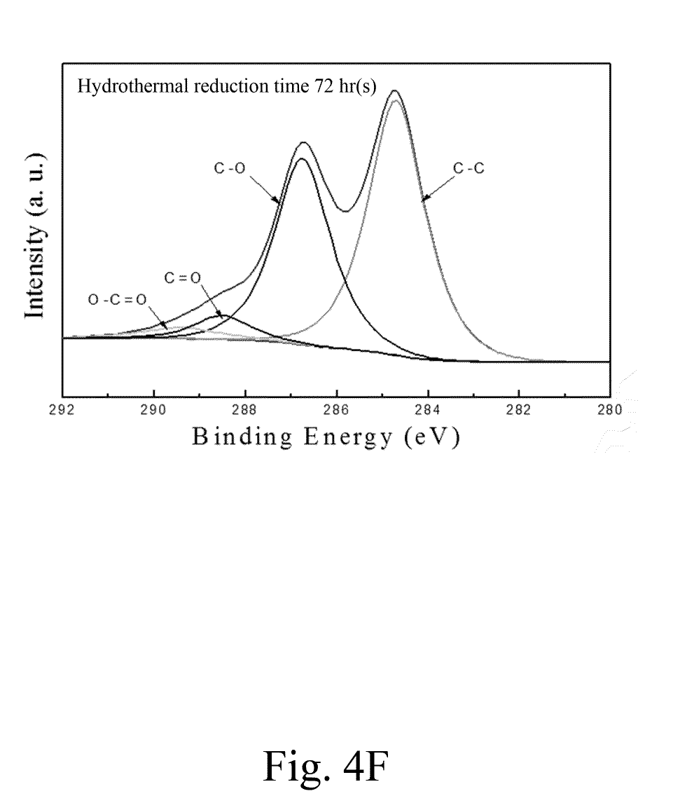

Please refer to Table 1 and FIGS. 4A-4F. Table 1 and FIGS. 4A-4F shows the ratio C/O content structure diversification of reduced graphene oxide 10 (r-GO) under different hydrothermal reduction time. The data is obtained from X-ray photoelectron spectroscopy (XPS) analyzing assay. The data in table 1 shows that the percentage of C—C bond (C—C%) of reduced graphene oxide 10 (r-GO) increases obviously as the hydrothermal reduction time increases from 0 hour to 72 hours; at the same time, the ratio of C—C bond and C—O bond (C—C/C—O%) of reduced graphene oxide (r-GO) also increases.

TABLE 1
X-ray photoelectron spectroscopy (XPS) data of r-GO

| Hydrothermal reduction | C—C | C—O | O—C═O | C═O | C—C/C—O |
|---|---|---|---|---|---|
| time of r-GO (hours) | (%) | (%) | (%) | (%) | (%) |
| 0 | 39.13 | 47.51 | 4.16 | 9.18 | 0.82 |
| 6 | 42.50 | 48.81 | 1.98 | 6.69 | 0.87 |
| 12 | 43.28 | 47.25 | 2.80 | 6.65 | 0.91 |
| 24 | 47.71 | 43.74 | 3.13 | 5.41 | 1.09 |
| 48 | 49.18 | 42.61 | 3.75 | 4.45 | 1.15 |
| 72 | 53.44 | 38.5 | 3.17 | 4.87 | 1.38 |

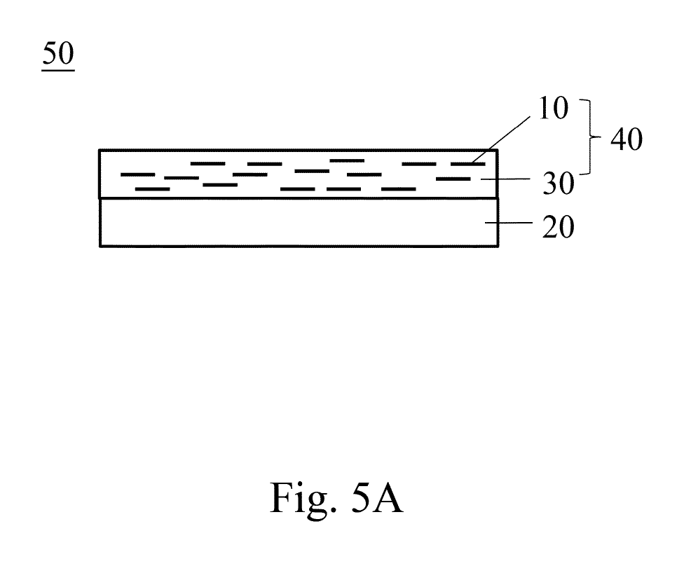

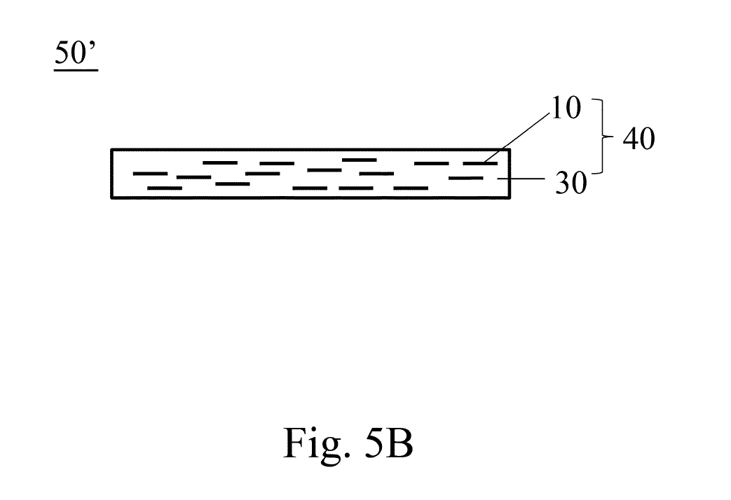

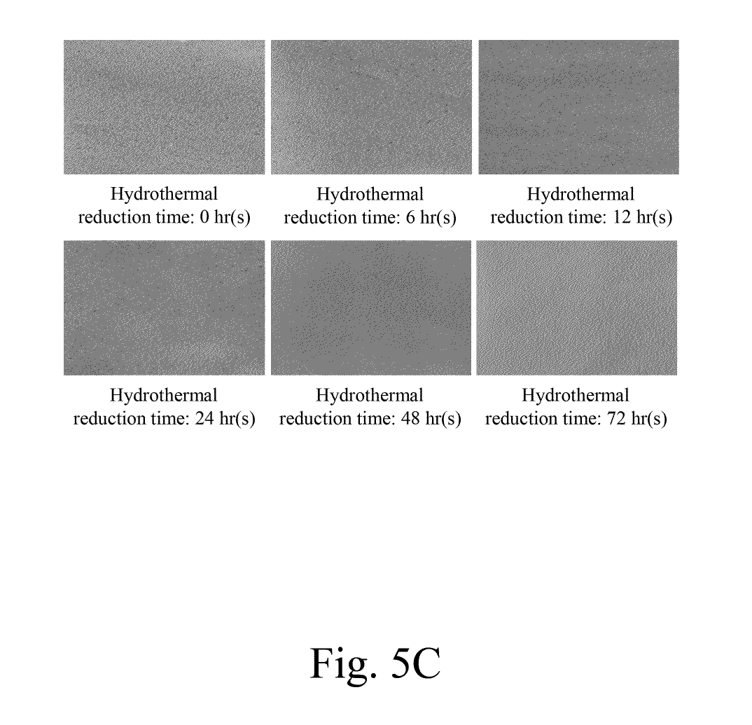

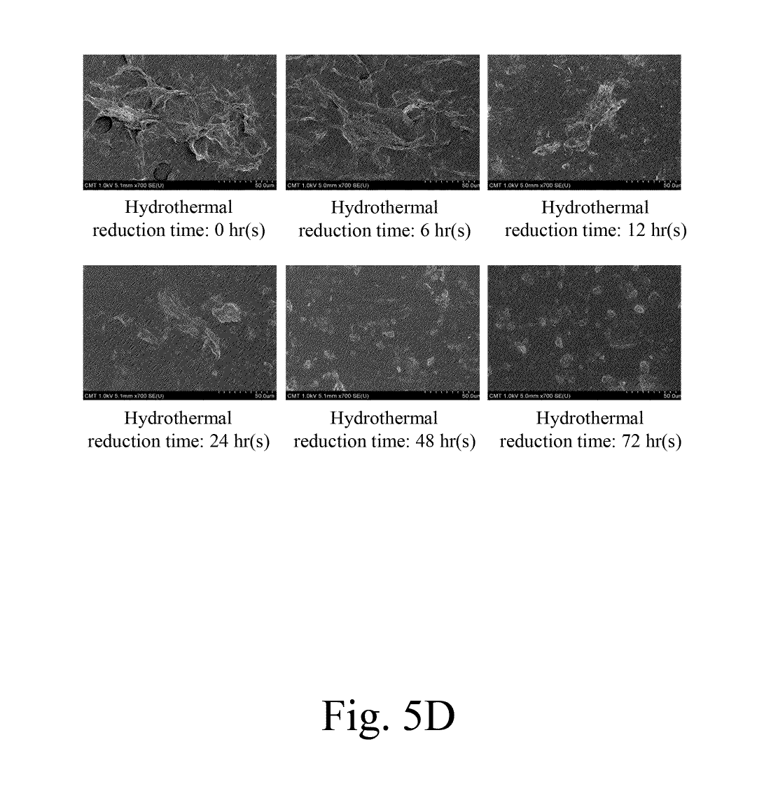

Please refer to FIG. 5A. The fourth embedment, as showed in FIG. 5A, provides a macromolecule composite sheet 50, which includes a macromolecule sheet complex 40 and a macromolecule supporting material 20. The macromolecule sheet complex 40 includes plural reduced graphene oxide 10 (r-GO) and macromolecule 30. The production of the macromolecule sheet complex 40 is as followed: add the reduced graphene oxide 10 (r-GO) dispersion solution which obtained from embedment 3 to the solution of macromolecule 30 to form a molding solution, and then, mold the molding solution on the surface of macromolecule supporting material 20 to form a macromolecule sheet complex 40. The macromolecule sheet complex 40 with porous, and the pore sizes of the sheet ranging from 0.01 millimeter to 1 millimeter. The macromolecule 30 which forms macromolecule sheet complex 40 is chitosan, and in other embedment, can be PVC, PSF, PVDF, PU, or PAN.

The fifth embedment, please refer to FIG. 5B. The macromolecule sheet complex 40 can also work without macromolecule supporting material 20. Please refer to FIG. 5C. FIG. 5C shows the photos of surfaces of macromolecule sheet complex 40 formed by the solution of macromolecule 30 and reduced graphene oxide 10 (r-GO) dispersion solution under different hydrothermal reduction times. Obviously, as the hydrothermal reduction time increased from 0 hour to 72 hours, the smoothness of macromolecule sheet complex 40 upgraded. Please further refer to FIG. 5D. FIG. 5D shows the electron microscopy photos of sheets showed in FIG. 5C. Photos in FIG. 5D also shows that the surface smoothness of macromolecule sheet complex 40 upgrading within reduction time.

The different reduction time of reduced graphene oxide 10 results different ratio of C/O content structure, and further, the different chemical proprieties. By control the reduction time of reduced graphene oxide 10, reduced graphene oxide 10 affine to different macromolecules of different proprieties can be obtained. Selecting proper reduction time of graphene oxide can avoid aggregation of reduced graphene oxide 10 and obtain macromolecule sheet complex 40 of high surface area and surface roughness as low as nano grade. Therefore, the contact area between macromolecule sheet complex 40 is increased to raise the effectiveness separation of the solution. Please refer to Table 2. Table 2 is the separation effectiveness result table of macromolecule composite sheet 50 under room temperature, of different solvent and water. When the mentioned solvent is alcohols, which can be methanol, ethanol, propanol and isopropanol. In one embedment, the solution to be separated comprises water and isopropanol. In one embedment, the macromolecule composite sheet 50 is formed by reduced graphene oxide 10 dispersion hydrothermal reduced under 194° F. (90° C.), reduction time 12 hours, on the surface of macromolecule supporting material 20. The resulted separation effectiveness of the macromolecule composite sheet 50 to the mixed solution of water and isopropanol can be higher than 99%.

TABLE 2
separation effectiveness result table
of macromolecule composite sheet

| | | Hydrothermal | | | Separation |
|---|---|---|---|---|---|
| num- | Mixed Solution | reduction time | | Filtered flow | effectiveness |
| ber | to be separated | (194° F.) | | (g/m² hr) | (%) |
| 1 | Isopropanol + water | 0 | (hrs) | 1478.75 | 95.89 ± 5.81 |
| 2 | Isopropanol + water | 6 | (hrs) | 1293.01 | 99.68 ± 0.45 |
| 3 | Isopropanol + water | 12 | (hrs) | 1825.40 | 99.28 ± 0.05 |
| 4 | Isopropanol + water | 48 | (hrs) | 1567.09 | 98.12 ± 0.82 |
| 5 | Isopropanol + water | 72 | (hrs) | 1172.45 | 93.32 ± 3.79 |

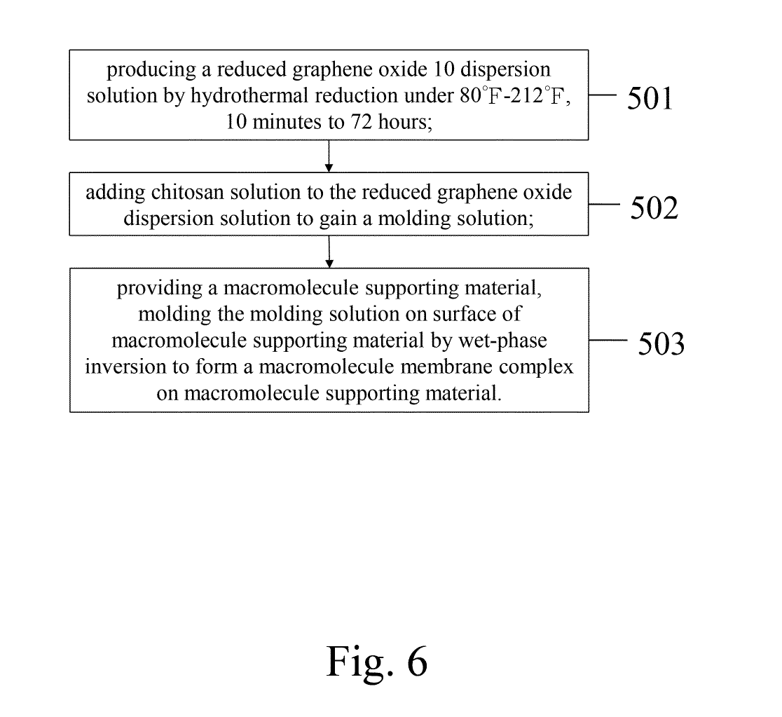

Please refer to FIG. 6. the fourth embedment. The fabricating method of macromolecule composite sheet involves following steps: step 501: producing a reduced graphene oxide dispersion solution by hydrothermal reduction under 80° F.-212° F. (30° C.-100° C.), 10 minutes to 72 hours; step 502: adding chitosan solution to the reduced graphene oxide dispersion solution to gain a molding solution of 33.3 wt %; step 503: providing a macromolecule supporting material 20, molding the molding solution on surface of macromolecule supporting material 20 by wet-phase inversion to form a macromolecule sheet complex 40 on macromolecule supporting material 20.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A graphene filtering sheet, comprising:
a reduced graphene oxide, which has a ratio of C/O (carbon/oxygen) content structure of 0.1-50, the reduced graphene oxide was dispersed in a macromolecule to become a macromolecule composite sheet.

2. The graphene filtering sheet of claim 1, wherein the pore sizes of the macromolecule composite sheet ranging from 1 μm-100 μm.

3. The graphene filtering sheet of claim 1, wherein the macromolecule is selected from the group consisted of chitosan, PVC, PSF, PVDF, PU, and PAN.

4. The graphene filtering sheet of claim 1 further comprising a macromolecule supporting material, and the macromolecule composite sheet is formed on the macromolecule supporting material.

5. The graphene filtering sheet of claim 1, wherein the graphene filtering sheet has a capacity of separating alcohol from water with an efficiency higher than 99%.

6. The graphene filtering sheet of claim 5, wherein the alcohol is selected from the group consisted of methanol, ethanol, propanol and isopropanol.

7. A method for fabricating a graphene filtering sheet, comprises the steps of:
adding a graphene oxide in water to delaminate the graphene oxide to obtain a graphene oxide dispersion solution;
performing a hydrothermal reduction process to the graphene oxide dispersion solution at a constant temperature ranging from 30° C.-100° C., and at a constant time period from 10 minutes to 72 hours, to obtain a reduced graphene oxide dispersion solution with a C/O ratio of 0.1-50; and
drying the reduced graphene oxide (r-GO) dispersion solution.

8. The method of claim 7, wherein the step of drying the reduced graphene oxide (r-GO) dispersion solution is achieved by vacuum filtration.

9. The method of claim 7, wherein the delamination of the graphene oxide is achieved by sonication.

10. The method of claim 7, further comprises adding a macromolecule solution into the reduced graphene oxide (r-GO) dispersion solution.
